(19) United States
(12) Patent Application Publication
(10) Pub. No.: US 2013/0073330 A1
(43) Pub. Date: Mar. 21, 2013

(54) INTER-APPLICATION OBJECT AND RECORD ACTIONS

(71) Applicants: Michael J. McCormack, Snohomish, WA (US); Wayne C. Parker, III, Bellevue, WA (US); Dmitri Davydok, Bellevue, WA (US); Navin Thadani, Bothell, WA (US); Nick Thomson, Redmond, WA (US); David Shutt, Seattle, WA (US); Ian Legler, Redmond, WA (US)

(72) Inventors: Michael J. McCormack, Snohomish, WA (US); Wayne C. Parker, III, Bellevue, WA (US); Dmitri Davydok, Bellevue, WA (US); Navin Thadani, Bothell, WA (US); Nick Thomson, Redmond, WA (US); David Shutt, Seattle, WA (US); Ian Legler, Redmond, WA (US)

(73) Assignee: Microsoft Corporation, Redmond, WA (US)

(21) Appl. No.: 13/239,366

(22) Filed: Sep. 21, 2011

(51) Int. Cl. G06Q 10/00

(52) U.S. Cl. 705/7.21

(57) ABSTRACT

Architecture that facilitates support for similar user interface (UI) models and user experience of independent applications. A data mapping component is provided that maps a user record of a business-centric application to a business object of the business-centric application. When employed in combination with another independent application, such as a personal information manager (PIM), a PIM component exposes the business object via a PIM user interface in a personalized way that enables user interaction with the business object to apply PIM actions to the business object. The mapping component can be a join table between the user record and the business object that enables the setting of PIM settings and user interface actions into the business product. Additionally, a communications infrastructure is provided where the PIM client UI communicates to the data-based server system in the business environment and persists PIM-specific settings to the business object.

### BACKGROUND

It has been traditional that applications are designed to operate independently with corresponding user experiences. However, developers have realized that consumers become accustomed to certain user experiences, and hence, prefer to access other applications via these interfaces, a capability yet to be provided for rich inter-application usage.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture facilitates support for similar user interface (UI) models and user experience of independent applications. In one implementation, a data mapping component is provided that maps a user record of a business-centric application to a business object of the business-centric application. When employed in combination with another independent application, such as a personal information manager (PIM), a PIM component exposes the business object via a PIM user interface in a personalized way that enables user interaction with the business object to apply PIM actions to the business object.

In a more specific implementation, the mapping component can be a join table between the user record and the business object that enables the setting of PIM settings and user interface actions into the business product. Additionally, a communications infrastructure is created where the PIM client UI communicates to the data-based server system in the business environment and persists PIM-specific settings to the business object.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a system in accordance with the disclosed architecture.

FIG. 2 illustrates a flow diagram that represents aspects of the system of FIG. 1.

FIG. 3 illustrates an exemplary client PIM user interface that facilitates user interaction with business information.

FIG. 4 illustrates an exemplary client PIM user interface that facilitates user interaction with business information.

FIG. 5 illustrates a computer-implemented method in accordance with the disclosed architecture.

FIG. 6 illustrates further aspects of the method of FIG. 5.

FIG. 7 illustrates an alternative computer-implemented method in accordance with the disclosed architecture.

FIG. 8 illustrates further aspects of the method of FIG. 7.

FIG. 9 illustrates a block diagram of a computing system that executes inter-application object and record actions in accordance with the disclosed architecture.

### DETAILED DESCRIPTION

The disclosed architecture facilitates support for similar user interface (UI) models and user experience of independent applications. In one implementation, a data mapping component is provided that maps a user record of a business-centric application to a business object of the business-centric application. The architecture includes optimization for non-entered data, and client settings and client UI to unrelated server data structures and storage.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

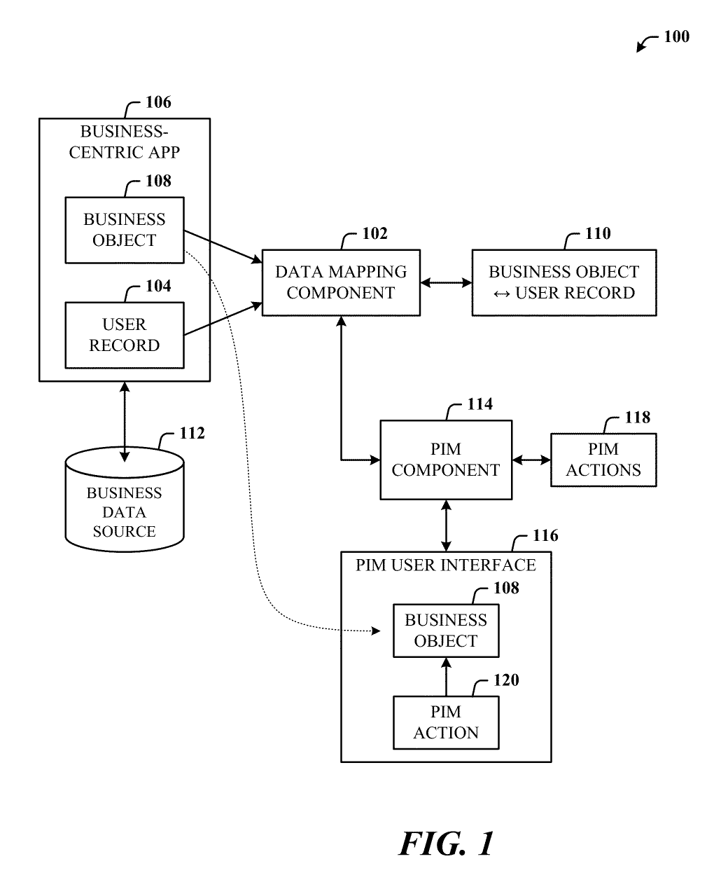

FIG. 1 illustrates a system 100 in accordance with the disclosed architecture. The system 100 includes a data mapping component 102 that maps a user record 104 of a business-centric application 106 to a business object 108 of the business-centric application 106. In other words, a relationship 110 is created between the user record 104 and the business object 108. The business-centric application 106 can be associated with a business data source 112. A personal information manager (PIM) component 114 exposes the business object 108 via a PIM user interface 116 in a personalized way that enables user interaction with the business object 108 to apply one or more of the PIM actions 118 (e.g., an action 120) to the business object 108.

The data mapping component 102 can include a contents table of user records and business objects. The data mapping component 102 can include a personalization table that stores properties associated with reminder functionality, follow-up functionality, and category functionality. The personalization table can be joined with a results set of an entity type when the contents table includes a categories column, the personalization table joined to provide a complete category-type property value. The PIM action can be a reminder action, a follow-up action, and/or a grouping action (e.g., category). The PIM component 114 propagates a change in a PIM construct to a data change in the business object 108.

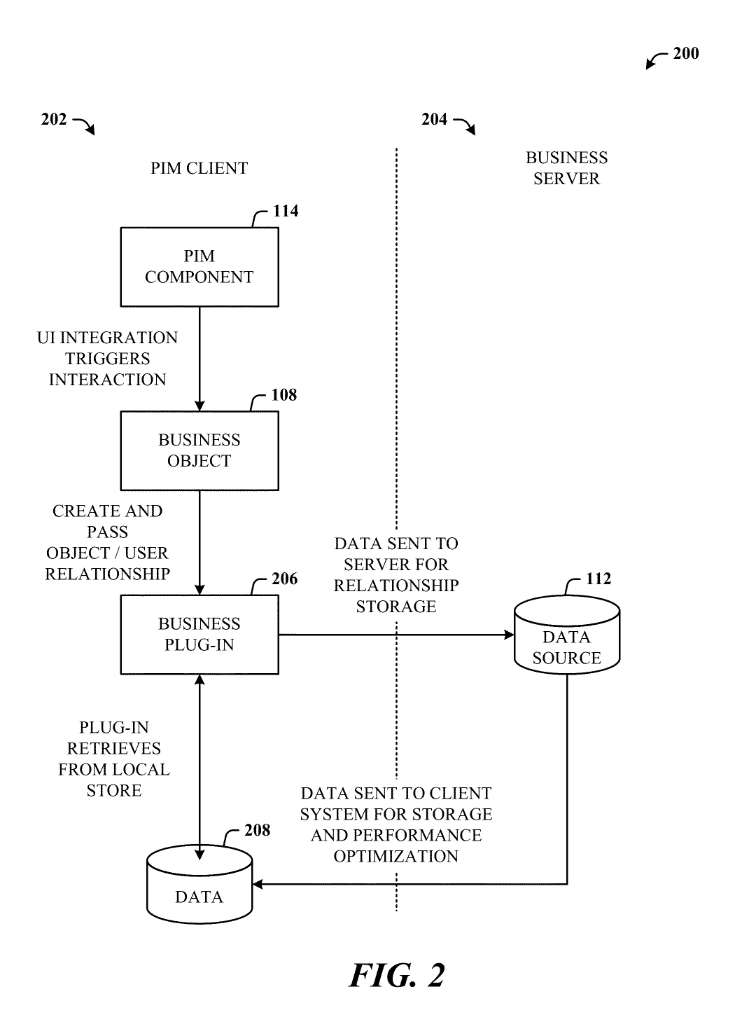

FIG. 2 illustrates a flow diagram that represents aspects of the system 100 of FIG. 1. The system 200 illustrates a PIM client side 202 (e.g., Outlook™ by Microsoft Corporation) and a business server side 204 (e.g., Customer Relationship Manager™ (CRM) by Microsoft Corporation). Beginning on the client side 202, flow begins from the PIM component 114 where when the user initiates navigation to the business environment via the PIM client, UI integration of the business-centric application and the PIM client triggers the capability to interact between the PIM application and the business-centric application. Thus, the user is able to access one of many business objects (e.g., business object 108, such as a CRM entity instance record of a CRM entity) via the PIM client 202. The object—user relationship (e.g., relationship 110) is then created and passed to a business plug-in 206 of the PIM client. This data is then sent to the server for storage in the business data source 112. The data can then also be sent (from the business data source 112) to a PIM client data source 208 for storage and performance optimization of the client. The client plug-in will then retrieve the data (which is available) from the client data source 208, before accessing the server data source 112.

Following is a more detailed description of the inter-application object and record actions capabilities. The description details reminder and follow-up actions; however, it is to be understood that the disclosed architecture applies equally to other suitable actions as well (e.g., category).

With respect to reminders and follow-ups, the representation of reminders and follow-ups act seamlessly across the business-centric application and PIM platforms. For example, in one PIM implementation, the user you can initiate a right-click menu, flag a reminder, set a follow-up, etc. These PIM properties are tracked on the business item. The PIM properties can be great in number. The user can set these properties on a transient business object (e.g., a persistent folder). In a PIM client such as Outlook, for example, built-in background MAPI tables (a MAPI object, of rows as objects and columns as object properties, that is used to view a collection of properties belonging to other MAPI objects of a particular type) can be provided (e.g., a table for Reminders and a table for To-Dos).

Following are example of stored values for the reminder: Flag, Start Date, Due Date, Reminder, Reminder Date, and Time. When the PIM client goes offline, the reminders and to-dos also go offline.

All the standard MAPI properties that comprise the follow-up, reminders and categories functionality can be stored in a separate personalization table (e.g., denoted as PerUserPerItemData) in the business server 204. When the PIM client 202 sends a request to the business data source 112 for a contents table of the Reminders folder or the To-Do folder, the data for such a MAPI table comes from the personalization table. When a contents table of a business objects folder includes the Categories column, the personalization table is joined with the results set of the entity type to provide the complete Categories property value.

Following is a listing of exemplary columns for the reminders and to-dos functionality.

| Column Name | Type |
|---|---|
| CommonEnd | DateTime |
| CommonStart | DateTime |
| DueDate | DateTime |
| FlagDueBy | DateTime |
| FlagRequest | Nvarchar (100) |
| FlagStatus | Int |
| ObjectId | Lookup (Guid) |
| ObjectTypeCode | Int |
| OwnerId | Owner (Guid) |
| OwningBusinessUnit | Lookup (Guid) |
| PersonalCategories | Nvarchar (Max) |
| ReminderSet | Bool |
| ReminderTime | DateTime |
| StartTime | DateTime |
| ToDoItemFlags | Int |
| ToDoOrdinalDate | DateTime |
| ToDoSubordinal | Nvarchar (100) |
| ToDoTitle | Nvarchar (4000) |

An assumption is that the number of items containing a non-empty set of personal data for each user, is reasonably low (all such items have been manually individually touched by the user at some moment and all the items with non-empty follow-up and reminders data are showing up in the user's To-Do bar), so the total size of the personalization table is going to be manageable.

Make this a standard user-owned entity!

```
CREATE TABLE [dbo].[PerUserPerItemData](
    [UserId] [uniqueidentifier] NULL,
    [ObjectId] [uniqueidentifier] NULL,
    [ObjectTypeCode] [int] NULL,
    [ReminderSet] [bit] NULL,
    [ReminderTime] [datetime] NULL,
    [StartDate] [datetime] NULL,
    [DueDate] [datetime] NULL,
    [FlagDueBy] [datetime] NULL,
    [CommonStart] [datetime] NULL,
    [CommonEnd] [datetime] NULL,
    [FlagRequest] [nvarchar](100) NULL,
    [ToDoOrdinalDate] [datetime] NULL,
    [ToDoSubOrdinal] [nvarchar](100) NULL,
    [ToDoTitle] [nvarchar](100) NULL,
    [PersonalCategories] [nvarchar](max) NULL,
    [FlagStatus][int] NULL,
    [ToDoItemFlags][int] NULL
)
```

Following are example usage scenarios of the disclosed architecture. Categories, follow-up, and/or reminders related columns can be included in a column set of a MAPI contents table for a business objects folder. The PIM client calls GetContentsTable( ) SetColumns( ) etc. The personalization table is included in the join in the fetch that retrieves the contents table data.

A business item is opened in the PIM client (e.g., row selected and acted upon; reading pane is instantiated; inspector is opened). The PIM client calls OpenEntry( ) and the personalization table is included in the join in the fetch that retrieves the item property bag data.

The built-in PIM client UI for follow-up, reminders, and [personal] categories causes data to be stored in the personalization table. The user adds a personal category or configures follow-up/reminder from a view context menu or an inspector ribbon. The PIM client calls SetProps( ) and SaveChanges( ) on the IMessage in a business data source. The MAPI provider updates a row in the personalization table.

When the PIM client displays the Reminders window or the To-Do list, the PIM client calls GetContentsTable( ) on the Reminders or the To-Do search folder, and the business MAPI provider collects results from all applicable entity types and returns the aggregate data.

The Search Folders for To-Do and Reminders can be implemented as multi-entity folders, which know about multiple data sources (entities) on the business server. The data caching mechanism can be configured to support multiple sources and the per-user entity. Three distinct scenarios that are supported include the following.

A first scenario is where the user is viewing an existing business folder, such as a Contacts folder, but has added personalization columns to the list of columns for the view. In this scenario, the data is retrieved from the server (business data source 112) in a single fetch call with a join against the personalization table.

A second scenario is where data from a bounded set of folders is being displayed, such as those that populate an activity pointers folder, including personalization columns. In this scenario, the data in the cache (PIM client) is retrieved in multiple fetch requests, one per source entity, with a join against the personalization table in each one.

A third scenario supports the To-Do and Reminders folders, where the primary source of the data is the personalization table. In this scenario, the cache is populated initially from the personalization table. Using the results from the initial fetch, additional fetches are made for the additional data needed for those items in each entity type.

With respect to performance considerations, and since the fundamental assumption that the number of items containing non-empty set of personal data for each user is reasonably low, the total size of the personalization table and its performance when queries for a specific user is manageable. An alternative design is to have one PerItemData table per user.

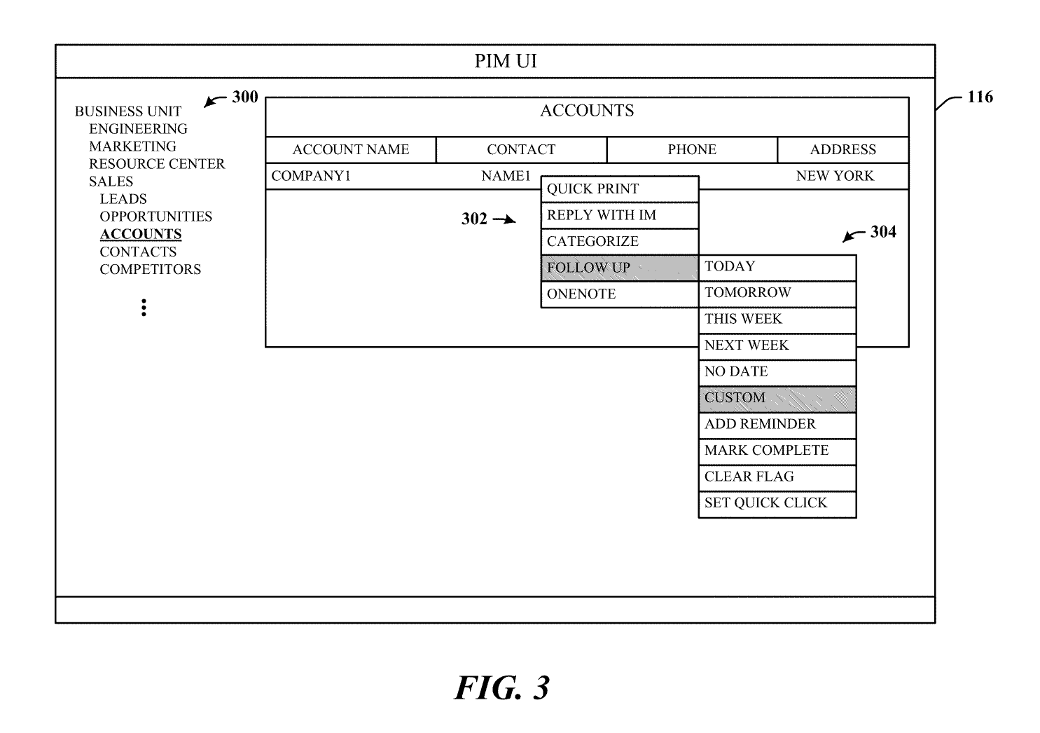

FIG. 3 illustrates an exemplary client PIM user interface 116 that facilitates user interaction with business information. Here, the PIM UI 116 shows Accounts information for a Company1, the Accounts business information selected from a listing of business information 300. The PIM user can then apply PIM actions 118 via an actions drop-down menu 302 to the Company1 property of the business object Account Name. The actions 118 can include a print functionality (Quick Print), a communications option (Reply with IM), a grouping action (Category), follow-up functionality (Follow-Up), and planner/note taking functionality (OneNote™ by Microsoft Corporation). Here, the user has selected follow-up functionality, which further expands to provide more detailed follow-up functionality such as for scheduling and annotation details menu 304 (e.g., today, tomorrow, this week, next week, no date, custom, add reminder, mark complete, clear flag, and set quick click) of the follow-up.

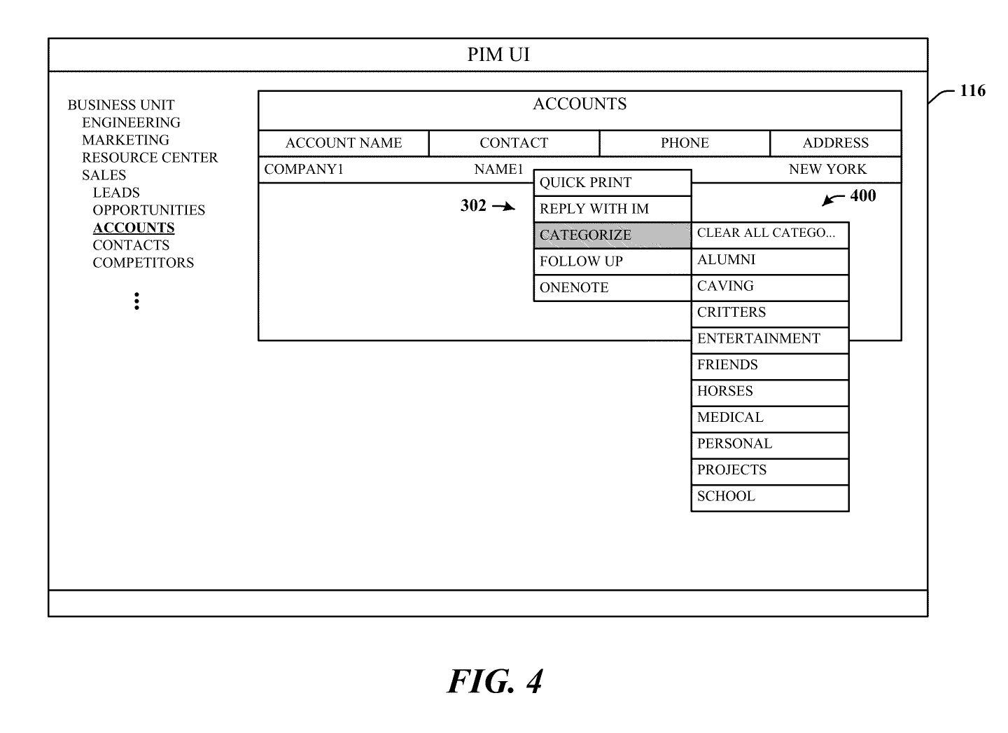

FIG. 4 illustrates an exemplary client PIM user interface 116 that facilitates user interaction with business information. Here, the PIM user applies a grouping action (Category) to the Company1 property of the Account Name business object. Here, the user has selected grouping functionality (Category) of the drop-down menu 302, which further expands to a details menu 400 to provide more detailed grouping functionality such as categories for Alumni, Caving, Critters, etc.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

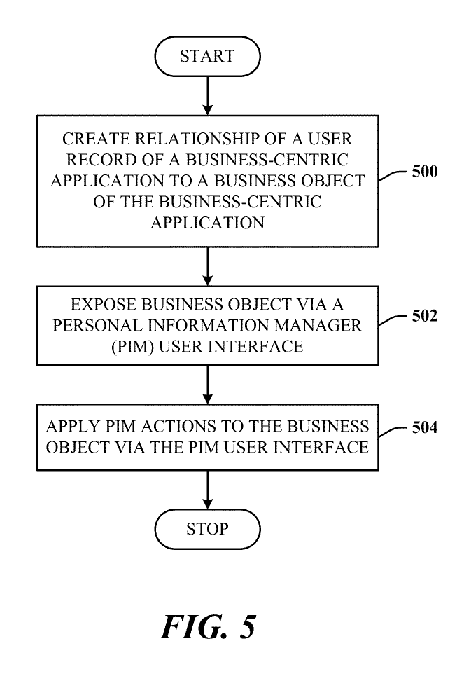

FIG. 5 illustrates a computer-implemented method in accordance with the disclosed architecture. At 500, a relationship is created of a user record of a business-centric application to a business object of the business-centric application. At 502, the business object is exposed via a personal information manager (PIM) user interface. At 504, PIM actions (e.g., reminders, follow-ups, categories, etc.) are applied to the business object via the PIM user interface.

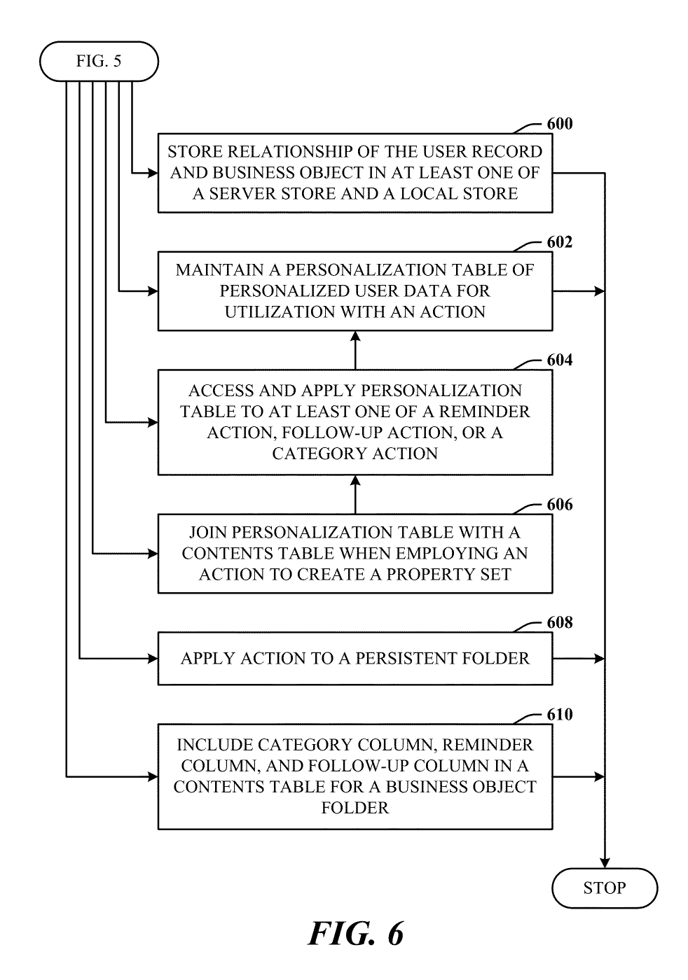

FIG. 6 illustrates further aspects of the method of FIG. 5. Note that the flow indicates that each block can represent a step that can be included, separately or in combination with other blocks, as additional aspects of the method represented by the flow chart of FIG. 5. At 600, the relationship of the user record and business object is stored in at least one of a server store and a local store. At 602, a personalization table of personalized user data is maintained for utilization with an action. At 604, the personalization table is accessed and applied to at least one of a reminder action, follow-up action, or a category action. At 606, the personalization table is joined with a contents table when employing an action to create a property set. At 608, the action is applied to a persistent folder. At 610, a category column, reminder column, and follow-up column can be included in a contents table for a business object folder.

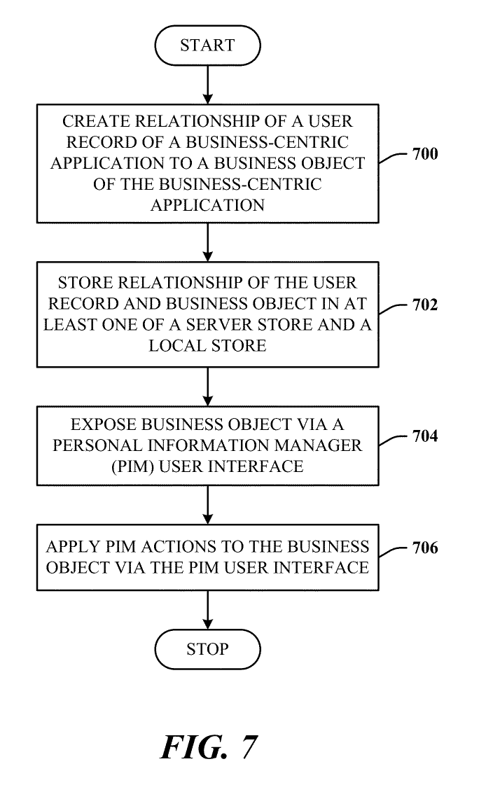

FIG. 7 illustrates an alternative computer-implemented method in accordance with the disclosed architecture. At 700, a relationship is created between a user record of a business-centric application and a business object of the business-centric application. At 702, the relationship of the user record and business object is stored in at least one of a server store and a local store. At 704, the business object is exposed via a personal information manager (PIM) user interface. At 706, PIM actions are applied to the business object via the PIM user interface.

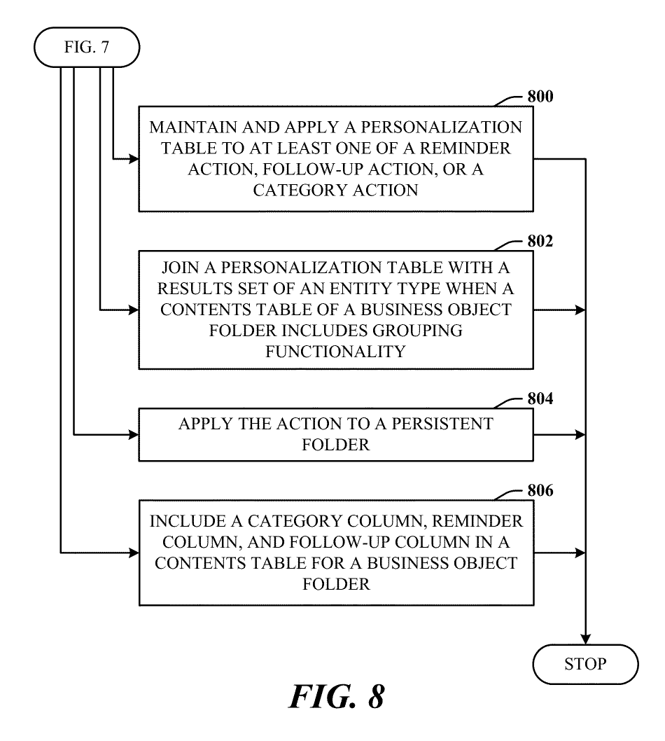

FIG. 8 illustrates further aspects of the method of FIG. 7. Note that the flow indicates that each block can represent a step that can be included, separately or in combination with other blocks, as additional aspects of the method represented by the flow chart of FIG. 7. At 800, a personalization table is maintained and applied to at least one of a reminder action, follow-up action, or a category action. At 802, a personalization table is joined with a results set of an entity type when a contents table of a business object folder includes grouping functionality. At 804, the action is applied to a persistent folder. At 806, at least one of a category column, reminder column, or follow-up column is included in a contents table for a business object folder.

As used in this application, the terms “component” and “system” are intended to refer to a computer-related entity, either hardware, a combination of software and tangible hardware, software, or software in execution. For example, a component can be, but is not limited to, tangible components such as a processor, chip memory, mass storage devices (e.g., optical drives, solid state drives, and/or magnetic storage media drives), and computers, and software components such as a process running on a processor, an object, an executable, a data structure (stored in volatile or non-volatile storage media), a module, a thread of execution, and/or a program. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

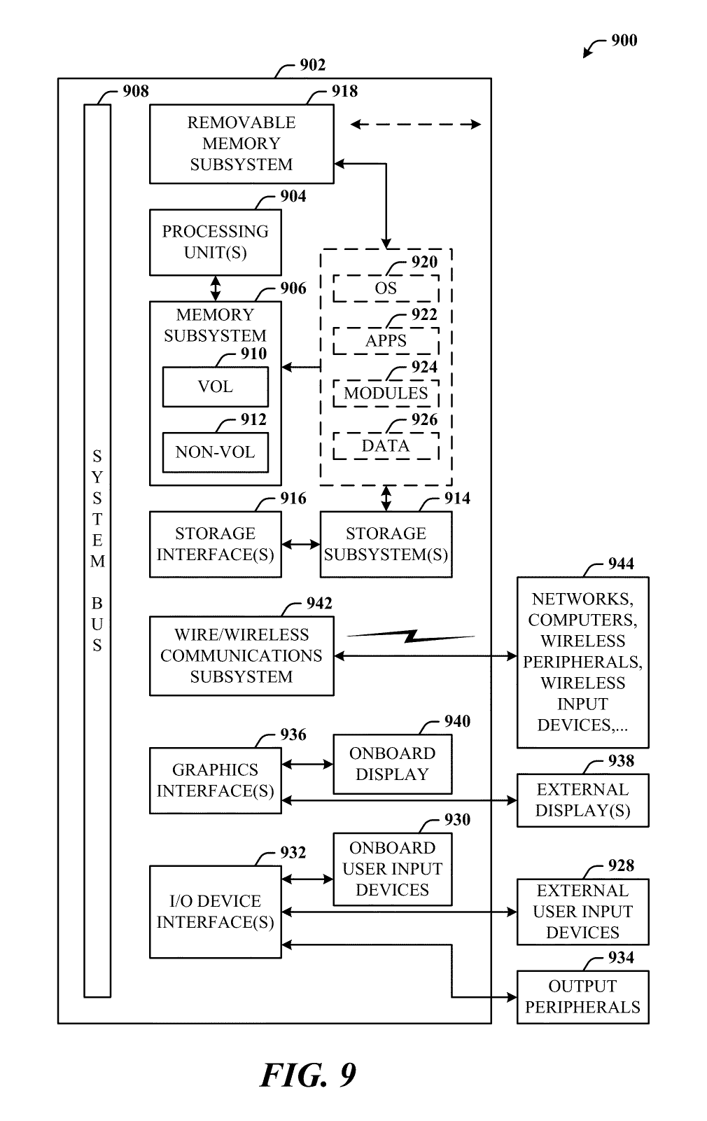

Referring now to FIG. 9, there is illustrated a block diagram of a computing system 900 that executes inter-application object and record actions in accordance with the disclosed architecture. However, it is appreciated that the some or all aspects of the disclosed methods and/or systems can be implemented as a system-on-a-chip, where analog, digital, mixed signals, and other functions are fabricated on a single chip substrate. In order to provide additional context for various aspects thereof, FIG. 9 and the following description are intended to provide a brief, general description of the suitable computing system 900 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 900 for implementing various aspects includes the computer 902 having processing unit(s) 904, a computer-readable storage such as a system memory 906, and a system bus 908. The processing unit(s) 904 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 906 can include computer-readable storage (physical storage media) such as a volatile (VOL) memory 910 (e.g., random access memory (RAM)) and non-volatile memory (NON-VOL) 912 (e.g., ROM, EPROM, EEPROM, etc.). A basic input/output system (BIOS) can be stored in the non-volatile memory 912, and includes the basic routines that facilitate the communication of data and signals between components within the computer 902, such as during startup. The volatile memory 910 can also include a high-speed RAM such as static RAM for caching data.

The system bus 908 provides an interface for system components including, but not limited to, the system memory 906 to the processing unit(s) 904. The system bus 908 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 902 further includes machine readable storage subsystem(s) 914 and storage interface(s) 916 for interfacing the storage subsystem(s) 914 to the system bus 908 and other desired computer components. The storage subsystem(s) 914 (physical storage media) can include one or more of a hard disk drive (HDD), a magnetic floppy disk drive (FDD), and/or optical disk storage drive (e.g., a CD-ROM drive DVD drive), for example. The storage interface(s) 916 can include interface technologies such as EIDE, ATA, SATA, and IEEE 1394, for example.

One or more programs and data can be stored in the memory subsystem 906, a machine readable and removable memory subsystem 918 (e.g., flash drive form factor technology), and/or the storage subsystem(s) 914 (e.g., optical, magnetic, solid state), including an operating system 920, one or more application programs 922, other program modules 924, and program data 926.

The operating system 920, one or more application programs 922, other program modules 924, and/or program data 926 can include entities and components of the system 100 of FIG. 1, entities and components of the flow diagram 200 of FIG. 2, the PIM client user interface of FIG. 3, the PIM client user interface of FIG. 4, and the methods represented by the flowcharts of FIGS. 5-8, for example.

Generally, programs include routines, methods, data structures, other software components, etc., that perform particular tasks or implement particular abstract data types. All or portions of the operating system 920, applications 922, modules 924, and/or data 926 can also be cached in memory such as the volatile memory 910, for example. It is to be appreciated that the disclosed architecture can be implemented with various commercially available operating systems or combinations of operating systems (e.g., as virtual machines).

The storage subsystem(s) 914 and memory subsystems (906 and 918) serve as computer readable media for volatile and non-volatile storage of data, data structures, computer-executable instructions, and so forth. Such instructions, when executed by a computer or other machine, can cause the computer or other machine to perform one or more acts of a method. The instructions to perform the acts can be stored on one medium, or could be stored across multiple media, so that the instructions appear collectively on the one or more computer-readable storage media, regardless of whether all of the instructions are on the same media.

Computer readable media can be any available media that can be accessed by the computer 902 and includes volatile and non-volatile internal and/or external media that is removable or non-removable. For the computer 902, the media accommodate the storage of data in any suitable digital format. It should be appreciated by those skilled in the art that other types of computer readable media can be employed such as zip drives, magnetic tape, flash memory cards, flash drives, cartridges, and the like, for storing computer executable instructions for performing the novel methods of the disclosed architecture.

A user can interact with the computer 902, programs, and data using external user input devices 928 such as a keyboard and a mouse. Other external user input devices 928 can include a microphone, an IR (infrared) remote control, a joystick, a game pad, camera recognition systems, a stylus pen, touch screen, gesture systems (e.g., eye movement, head movement, etc.), and/or the like. The user can interact with the computer 902, programs, and data using onboard user input devices 930 such a touchpad, microphone, keyboard, etc., where the computer 902 is a portable computer, for example. These and other input devices are connected to the processing unit(s) 904 through input/output (I/O) device interface(s) 932 via the system bus 908, but can be connected by other interfaces such as a parallel port, IEEE 1394 serial port, a game port, a USB port, an IR interface, short-range wireless (e.g., Bluetooth) and other personal area network (PAN) technologies, etc. The I/O device interface(s) 932 also facilitate the use of output peripherals 934 such as printers, audio devices, camera devices, and so on, such as a sound card and/or onboard audio processing capability.

One or more graphics interface(s) 936 (also commonly referred to as a graphics processing unit (GPU)) provide graphics and video signals between the computer 902 and external display(s) 938 (e.g., LCD, plasma) and/or onboard displays 940 (e.g., for portable computer). The graphics interface(s) 936 can also be manufactured as part of the computer system board.

The computer 902 can operate in a networked environment (e.g., IP-based) using logical connections via a wired/wireless communications subsystem 942 to one or more networks and/or other computers. The other computers can include workstations, servers, routers, personal computers, microprocessor-based entertainment appliances, peer devices or other common network nodes, and typically include many or all of the elements described relative to the computer 902. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 902 connects to the network via a wired/wireless communication subsystem 942 (e.g., a network interface adapter, onboard transceiver subsystem, etc.) to communicate with wired/wireless networks, wired/wireless printers, wired/wireless input devices 944, and so on. The computer 902 can include a modem or other means for establishing communications over the network. In a networked environment, programs and data relative to the computer 902 can be stored in the remote memory/storage device, as is associated with a distributed system. It will be appreciated that the network connections shown are exemplary and other means of establishing a communications link between the computers can be used.

The computer 902 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi™ (used to certify the interoperability of wireless computer networking devices) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A computer-implemented system, comprising:
a data-based business server system in a business environment comprising a business-centric application having a user experience;
a data mapping component that maps a user record of the business-centric application, employed by a user, to a business object of the business-centric application, for creating an object-user relationship between the user record and the business object, the business-centric application associated with a business data source of the business server system;
a personal information manager (PIM) component that initiates navigation to the business environment to expose the business object of the business-centric application to the user via a PIM user interface application, having a different user experience, in a personalized way that enables user interaction with the business object through the object-user relationship to apply PIM actions to the business object, thereby integrating the business-centric application and the PIM user interface application, for persisting PIM-specific settings to the business object; and
a processor that executes computer-executable instructions associated with at least one of the data mapping component or the PIM component.

2. The system of claim 1, wherein the data mapping component includes a contents table of user records and business objects.

3. The system of claim 2, wherein the data mapping component includes a personalization table that stores properties associated with reminder functionality, follow-up functionality, and category functionality.

4. The system of claim 3, wherein the personalization table is joined with a results set of an entity type when the contents table includes a categories column, the personalization table joined to provide a complete category-type property value.

5. The system of claim 1, wherein the PIM action is a reminder action.

6. The system of claim 1, wherein the PIM action is a follow-up action.

7. The system of claim 1, wherein the PIM action is associated with a grouping action.

8. The system of claim 1, wherein the PIM component propagates a change in a PIM construct to a data change in the business object.

9. A method, comprising:
employing at least one microprocessor configured to execute computer-executable instructions stored in memory to perform acts of:
implementing a business environment comprising a business-centric application having a user experience via a data-based business server system;
creating an object-user relationship between a user record of the business-centric application, employed by a user, and a business object of the business-centric application;
navigating to the business environment to expose the business object of the business-centric application to the user via a personal information manager (PIM) user interface application having a different user experience, to enable user interaction with the business object by providing integration of the business-centric application and a PIM client using the PIM user interface application;
applying PIM actions to the business object via the PIM user interface application; and
persisting PIM-specific settings to the business object via the PIM user interface application.

10. The method of claim 9, further comprising storing the relationship of the user record and business object in at least one of a server store and a local store.

11. The method of claim 9, further comprising maintaining a personalization table of personalized user data for utilization with an action.

12. The method of claim 11, further comprising accessing and applying the personalization table to at least one of a reminder action, follow-up action, or a category action.

13. The method of claim 12, further comprising joining the personalization table with a contents table when employing an action to create a property set.

14. The method of claim 9, further comprising applying the action to a persistent folder.

15. The method of claim 9, further comprising including a category column, reminder column, and follow-up column in a contents table for a business object folder.

16. A method, comprising:
employing at least one microprocessor configured to execute computer-executable instructions stored in memory to perform acts of:
implementing a business environment comprising a business-centric application having a user experience via a data-based business server system;
creating an object-user relationship between a user record of the business-centric application, employed by a user, and a business object of the business-centric application;
storing the relationship of the user record and business object in at least one of a server store and a local store;
navigating to the business environment to expose the business object of the business-centric application to the user via a personal information manager (PIM) user interface application having a different user experience;
providing integration of the business-centric application and a PIM client using the PIM user interface application;
applying PIM actions to the business object by user interaction via the PIM user interface application.

17. The method of claim 16, further comprising maintaining and applying a personalization table to at least one of a reminder action, follow-up action, or a category action.

18. The method of claim 16, further comprising joining a personalization table with a results set of an entity type when a contents table of a business object folder includes grouping functionality.

19. The method of claim 16, further comprising applying the action to a persistent folder.

20. The method of claim 16, further comprising including at least one of a category column, reminder column, or follow-up column in a contents table for a business object folder.
